(19) United States
(12) Patent Application Publication
(10) Pub. No.: US 2022/0234866 A1
(43) Pub. Date: Jul. 28, 2022

(54) DEVICE FOR CONNECTING A CONTROL DEVICE OF A PASSENGER-CONVEYING SYSTEM

(71) Applicant: Inventio AG, Hergiswil (CH)

(72) Inventor: Philippe Henneau, Zurich (CH)

(21) Appl. No.: 17/596,577

(22) PCT Filed: Jun. 19, 2020
(86) PCT No.: PCT/EP2020/067151

§ 371 Date: Dec. 14, 2021

(30) Foreign Application Priority Data
Jun. 21, 2019 (EP) 19181722.0

(51) Int. Cl. B66B 5/00; B66B 1/34; B66B 19/00

(52) U.S. Cl. CPC B66B 5/0025; B66B 19/007; B66B 1/3461

(57) ABSTRACT

A device for connecting a control device of a passenger transport installation to a communication unit for transmitting data to an entity remote from the passenger transport installation includes at least one detection unit detecting a first physical variable of the control device. The device further includes an evaluation unit generating a first electrical signal on the basis of the first physical variable detected. The device also includes a first interface connecting the device to the communication unit. The first electrical signal is transmitted to the communication unit via the first interface. The detection unit detects at least one of an electrical resistance, an electrical voltage, a visual state an acoustic signal of the control device as the first physical variable.

### FIELD

The invention relates to a device for connecting a control device of a passenger transport installation, a system for transmitting a state of a control device of a passenger transport installation, and a method for retrofitting a passenger transport installation.

### BACKGROUND

There is a need to remotely monitor the state of the passenger transport installation in order to be able to better coordinate the maintenance of the installation.

A device is known from JP 2002197215 A which uses an apparatus to tap the state of an elevator installation from the installation in order to then transmit this state to a remote unit.

Disadvantageously, subsequently attaching a state-monitoring and communication apparatus in existing installations is complex. The specifics of the installed control apparatus have to be known in order to integrate such monitoring. The control apparatus needs to be rebuilt, which requires a well-trained service technician. There is a risk that the control device will be damaged. Since old control devices often contain components that are no longer available, potential damage to the installation is particularly problematic. Failure of the control device may result in the need to replace additional structural units, and thus result in complex modifications.

### SUMMARY

An object of the present invention is to provide a device for connecting a control device of a passenger transport installation to a communication unit, in particular a communication unit remote from the device, for transmitting data to an entity remote from the passenger transport installation, and to a system for transmitting a state of a control device of a passenger transport installation, which device and system avoid the disadvantages of the prior art, and in particular to provide a method for retrofitting a passenger transport installation which allows status information to be tapped on the control device without the need for major modifications to the control device.

The object is achieved by a device for connecting a control device of a passenger transport installation, a system for transmitting a state of a control device of a passenger transport installation, and a method for retrofitting a passenger transport installation according to the following description.

According to the invention, the device for connecting a control device of a passenger transport installation to a communication unit, in particular a communication unit remote from the device, for transmitting data to an entity remote from the passenger transport installation comprises at least one detection unit for detecting a first physical variable of the control device. In a particularly preferred embodiment, the passenger transport installation is an elevator installation. In a particularly preferred embodiment, the communication unit is an Internet-enabled communication unit. The device further comprises an evaluation unit for generating a first electrical signal on the basis of the first physical variable. The device also comprises a first interface for connecting the device to the communication unit. The first electrical signal can be transmitted to the communication unit via the first interface. According to the invention, the detection unit is configured such that an electrical resistance and/or an electrical voltage and/or a visual state and/or an acoustic signal of the control device can be detected as the first physical variable.

Such a device allows physical variables of the control device to be tapped and transmitted to a communication unit. This makes it possible to detect a large number of different physical variables of the control device and communicate these via the communication unit to an entity remote from the passenger transport installation. The state of the control device can thus be determined by this entity without it being necessary to visit the passenger transport installation for this purpose. The device according to the invention makes it possible to detect a large number of physical variables. The device can thus be used for a large number of control devices. All older, common control devices can be covered with such a device. This allows existing installations to be retrofitted easily. The service technician can, equipped with one type of device, retrofit a large number of different installations.

The communication unit should be understood, above and in the following, as a communication unit which allows communication over long distances. The communication unit is preferably an Internet-enabled communication unit. The communication unit is preferably a communication unit which is remote from the device for connecting a control device of a passenger transport installation to a communication unit. In a particularly preferred embodiment, the communication unit is part of the passenger transport installation. The communication unit is independent of the device for connecting a control device of a passenger transport installation to the communication unit. It is therefore possible for the communication unit to have been retrofitted to the passenger transport installation before the integration of the device. The subsequent attachment of the device makes it possible for the control device to be more comprehensively connected to the communication unit.

Remote, above and in the following, should be understood to mean that the object described as remote is not part of the object from which it is remote. A communication unit that is remote from the device is thus not part of the device. This has the advantage that the communication unit is completely independent of the device. A passenger transport installation may already include a communication unit, for example. Such an installation can then be retrofitted with the device without creating redundancy in the communication unit.

A visual state should be understood to mean, above and in the following, a visual appearance that can have at least two different variants. A visual state is, for example, a status LED of a control device which lights up green during operation and does not light up in the event of a failure. Other visual states are also possible. A visual state can also be provided by a variety of status displays. For example, a visual state can comprise a plurality of status LEDs, it being possible for each of the status LEDs to assume two states, the states being a first color and a second color, for example. Further embodiments of such a visual state are very well known to a person skilled in the art.

An acoustic signal should be understood, above and in the following, as an acoustic tone which contains information. The acoustic signal can also assume at least two states. The first state of the acoustic signal can be the absence of an acoustic tone, for example. The second state of the acoustic signal can be e.g. the constant sounding of an acoustic tone with a constant frequency. The acoustic signal can, for example, also be characterized by a first state in which no acoustic tone sounds and a second state in which an acoustic tone sounds at regular intervals. Further embodiments of such an acoustic signal are very well known to a person skilled in the art.

An electrical resistance should also be understood, above and in the following, as a zero-ohmic connection, i.e. an electrical short circuit. The physical variable of the electrical resistance can in turn assume at least two states, a first state being characterized e.g. by a short circuit, i.e. a zero-ohmic electrical connection, and a second state being characterized e.g. by a high-ohmic, i.e. missing, electrical connection.

The physical variable of electrical voltage should be understood, above and in the following, to be able to assume at least two states. For example, in a first state, a zero voltage can characterize the physical variable of electrical voltage. In a second state, the electrical voltage can be 5 V, for example.

An interface should be understood, above and in the following, to enable contact, i.e. an electrical signal, to be tapped. Above and in the following, an interface does not just comprise a plug. An interface can be implemented by a variety of different physical connection elements, i.e. by clamping, screw, and plug connections of all types.

The first electrical signal should be understood, above and in the following, as a signal which can assume at least two states. A first state of the first electrical signal can be, for example, the absence of a voltage, i.e. 0 V. The second state of the first electrical signal can be a specific voltage, i.e. 5 V, for example. However, the electrical signal can also be formed by two different resistance values. For example, the electrical signal can be a closed line (0 ohm resistance) in a first state and an open line (very high resistance) in a second state.

In a preferred embodiment, the evaluation unit is configured in such a way that it can differentiate between a first state and a second state of the first physical variable. The first state signals that the passenger transport installation is functional. The second state signals that the passenger transport installation is not functional.

The device thus allows these two states to be detected and therefore makes it possible to know whether the control device is still functioning. This is very trivial and yet extremely important information for the service technician. This information can be tapped from the passenger transport installation by the device and then forwarded to a communication unit. The communication unit can then transmit this information to an entity outside the passenger transport installation and thus also make this information available at this remote entity. By checking this information at this remote entity (for example via an Internet portal), the service technician can obtain an initial picture of the installation based on the transmitted state before field deployment. This occurs analogously to the on-site overview when the service technician opens the control cabinet in which the control device is housed in order to see whether the control device is still functioning. The trivial information consisting of a first state (functional installation) and a second state (installation no longer functional) is often sufficient to obtain an initial overview of the possible sources of error.

Above and in the following, in a preferred embodiment, the functionality of the passenger transport installation is the functionality of the control device. In this embodiment, the first state of the first physical variable indicates that the control device is functional, while the second state indicates that the control device is not functional.

In a preferred embodiment, the evaluation unit is configured such that the first electrical signal can assume a first state or a second state. The evaluation unit has a switch. This switch can be used to switch the evaluation unit from a first operating mode to a second operating mode. The first electrical signal is inverted in the second operating mode compared with the first operating mode.

The evaluation unit with the switch thus allows the inversion of the first electrical signal to be transmitted to the communication unit. This makes it possible to ensure that the states of the first physical variable are correctly understood by the communication unit. For example, if the first state of the physical variable indicates that the installation is functional, the switch can be used to ensure that the electrical signal which is generated based on the state of this physical variable is also recognized by the communication unit as the “functional” state. Depending on the coding of the first physical variable, i.e. depending on the control device, this assignment can be wrong. The switch allows this assignment to be reversed. This ensures that a physical variable indicating that the control device is functional is correctly understood by the communication unit. This is particularly necessary because the physical variable can be present on the control device in a variety of forms. In particular, a visual signal can, e.g. in an off state, i.e. when no visual signal is present, indicate that a control device is functional, and indicate the opposite state, namely that the control device is not functional, in another control device. There is a switch for inverting the first electrical signal so that this variance can be taken into account.

The term “invert” means, above and in the following, that an electrical signal which can assume two states, is changed in the case of the first state by inversion to the second state and, vice versa, is changed in the case of the second state by inversion to the first state.

In a preferred embodiment, the evaluation unit is configured such that, when the first state of the first physical variable is detected, the first electrical signal is generated in the first state, with the evaluation unit, during operation in the second operating mode, generating the first electrical signal in the second state when the first state of the first physical variable is detected. In the second operating mode, the evaluation unit generates the first electrical signal in the first state when the second state of the first physical variable is detected.

In a preferred embodiment, the device also has a second and a third interface. The second interface is electrically connected within the device to the third interface in such a way that an electrical signal which is present at one of these interfaces is also available at the other of these interfaces (second and third interface).

This allows signals to pass through the device unchanged. For example, a signal from the communication unit can pass through the device unchanged to the control device. The second and third interfaces can be used to create an input and an output on the device by means of which an electrical signal can be easily looped through. In one embodiment, this signal can be tapped and analyzed in the device, but without the signal being changed in the process.

In a preferred embodiment, the device can be connected to a voltage source of the communication unit. The voltage source of the communication unit can thus be used to supply power to the device. The voltage source can preferably be connected to the device via the first interface.

This makes it possible to provide a device which itself does not contain a power supply. In this way, a device which is very simple, inexpensive, and reliable, i.e. not at risk of failure, is made possible. In particular, the existing voltage source in the communication unit can thus be used to supply power to the device. A redundant power supply is thus dispensed with, which allows a cost-effective design of the system consisting of the device and communication unit.

A voltage source should be understood, above and in the following, as an energy source that allows electronics to be supplied with power.

In a preferred embodiment, the device comprises an additional interface. The additional interface is configured to connect the device to at least one additional device, as described above and in the following.

Such an interface allows the connection and thus the use of multiple devices. The use of a plurality of devices makes it possible to monitor a plurality of physical variables of the control device. For example, a first device can be used to monitor a first physical variable in the form of a visual state and a second device can be used to monitor the first physical variable in the form of an electrical resistance. The first electrical signal generated on the basis of the physical variable of one of these devices can, for example, be transmitted to the other device via the additional interface. The additional interface thus allows several devices to be cascaded. It is thus possible to construct a more powerful device which allows a plurality of physical variables to be monitored and consists of a plurality of simple devices. Instead of a complex device, a large number of the very simple devices described above and below are interconnected, thus achieving the functionality of a complex device.

In a preferred embodiment, the device is configured such that, during operation, the first electrical signal of the additional device connected via the additional interface is OR-linked or AND-linked to the first electrical signal of the device. The signal resulting from the OR-link or AND-link can be transmitted to the communication unit via the first interface.

A number of physical variables can thus be monitored, for example. The OR-linked signal thus indicates a failure of the installation if at least one of the physical variables indicates such a failure. Only the OR-linked variable is then forwarded to the communication unit. This has the advantage that the communication unit only needs to be connected to one of the two devices and the connection can be carried out simply (no communication bus). The combination of the various devices that detect different physical variables already takes place in the device itself, and therefore only one of these devices then has to be connected to the communication unit. Depending on the type of signal, an AND-link can be selected instead of the OR-link. Further logical links and a possibility of choosing between these logical links are also possible and are well known to a person skilled in the art.

A system for transmitting a state of a control device of a passenger transport installation also achieves the object. The system comprises a communication unit for the transmission of data and an entity remote from the passenger transport installation. In a particularly preferred embodiment, the communication unit is Internet-enabled. The system further comprises at least one device as described above and below. The first device is connected to the communication unit via the first interface.

Such a system can be installed in existing passenger transport installations. This system then allows states of the passenger transport installation to be determined and the determined states to be communicated to an entity remote from the passenger transport installation. The system thus makes it possible to connect an existing passenger transport installation to an entity that is present at another location and thus to make the determined states of this passenger transport installation available to this entity.

An entity remote from the passenger transport installation means, above and in the following, an entity located outside the installation, i.e. an entity located outside the building in which the passenger transport installation is used, for example. The remote entity can in particular be a computer infrastructure. Such a computer infrastructure can be, for example, a server apparatus and can be referred to as a cloud.

The communication unit, as described above and below, is preferably an Internet-enabled communication unit, i.e. a communication unit that uses an Internet protocol to communicate with other Internet subscribers. The communication unit is characterized by the fact that it allows transmission over long distances, in particular that it allows the transmission of information from the passenger transport installation. In particular, the communication unit allows data to be transmitted to entities outside the building in which the passenger transport installation is located.

In a preferred embodiment, the system further comprises a second device. The first device is connected to the additional interface of the second device via the additional interface. In a particularly preferred embodiment, the first device and the second device are identical. In a particularly preferred embodiment, the detection unit of the first device is provided for detecting a first physical variable of the control device from the list comprising an electrical resistance, an electrical voltage, a visual signal from the control device, or an acoustic signal from the control device. In a particularly preferred embodiment, the detection unit of the second device is provided for detecting a second physical variable that is different from the first physical variable from the list comprising an electrical resistance, an electrical voltage, a visual state of the control device, or an acoustic signal of the control device.

Such a system allows the detection of two identical or, in the particularly preferred embodiment, two different physical variables. The system allows this detection through the dual use of a device as described above and below.

In a particularly preferred embodiment, the system further comprises a third device as described above and below. The third device is connected to the additional interface of the first and the second device via the additional interface. In a particularly preferred embodiment, the detection unit of the third device is provided for detecting a visual signal from the control device.

This embodiment makes it possible to detect three identical or three different physical variables and to transfer them to a communication unit. The additional interface of the first, second and third device creates a kind of bus in which the first electrical signals of the devices are combined. This allows the first electrical signal from the first device to be present at all other devices. The first electrical signal of the second device and the first electrical signal of the third device are also available at the other two devices. It is thus possible for each device to analyze all of the first electrical signals as a whole, connect them and then forward them to the communication unit. This makes it possible for only one of the devices to be connected to the communication unit. The connection from the device to the communication unit can thus be implemented very simply, i.e. with few electrical connections, i.e. with a forward and return conductor, for example. The particularly preferred embodiment allows the first device to detect an electrical voltage as the first physical variable and the second device to detect an electrical resistance as the first physical variable, for example, with the third device detecting a visual state as the first physical variable. This particularly preferred system thus allows a large number of different physical variables to be detected, analyzed, and transmitted.

In a preferred embodiment, the system is connected to the communication unit via the second interface of the first device. The third interface of the first device is configured for connection to the control device. In a particularly preferred embodiment, the first interface and the second interface are formed in one connection element.

Such a system makes it possible to transmit a control output at which a control signal from the communication unit can be tapped to the control device of the passenger transport installation via the device. In the particularly preferred embodiment, only a single connection of the device to the communication unit is necessary due to the implementation of the first interface and the second interface in one connection element. This makes it possible in particular to connect the device to the communication unit with minimal effort by one connection element of the device being connected, i.e. plugged, for example, to a connection element of the communication unit. A command which is transmitted from the communication unit to the second interface via the control output and unchanged via the third interface to the control device during operation can be, for example, a reset command which is received by the communication unit from a remote entity and then forwarded to the control device of the passenger transport installation via the device in order to restart the control device.

A method for retrofitting an existing passenger transport installation also achieves the object. The method comprises the step of attaching at least one device as described above and below. The method preferably further comprises the step of attaching a communication unit, in particular an Internet-enabled communication unit, for the transmission of data to an entity which is remote from the passenger transport installation and which can be connected to the device. A particularly preferred embodiment involves a method for retrofitting a passenger transport installation which is not Internet-enabled. A particularly preferred embodiment involves a method for retrofitting a passenger transport installation which is connected to the building management with parallel wiring. A particularly preferred embodiment involves a method for retrofitting an elevator installation.

Attaching at least one device can, above and in the following, include attaching the device to the passenger transport installation and connecting the device to the control device and the communication unit.

The communication unit is already present in some installations, and therefore the method step of attaching the communication unit is not necessary. If there is no communication unit, the step of attaching a communication unit becomes necessary.

Such a method makes it possible to connect data, in particular data on the functionality of the passenger transport installation, in particular the functionality of the control device, from old passenger transport installations which do not comprise means of communication with remote entities, i.e. Internet-enabled communication units, to a remote entity and then to transmit the data to the remote entity. Old passenger transport installations can be modernized using the method so that information on functionality can also be collected, analyzed, and retrieved from these installations in a central entity that is remote from the installation.

Internet-enabled, as used above and in the following, means that the passenger transport installation or the communication unit can be connected to the Internet and can therefore communicate over long distances via the Internet.

In a preferred embodiment, the method comprises steps for transmitting an operating state of a control device of the passenger transport installation to an entity remote from the passenger transport installation. This method includes the step of monitoring at least one physical variable of the control device which indicates that the control device is functional from the list comprising an electrical resistance, an electrical voltage, a visual state of the control device, or an acoustic signal of the control device. In a particularly preferred embodiment, the method comprises the step of continuously monitoring this physical variable. In a particularly preferred embodiment, the first physical variable is monitored using a device as described above and below. This method also comprises the step of transmitting an error message to an entity outside the passenger transport installation if the at least one physical variable indicates that the control device is not functional.

Such a method for retrofitting a passenger transport installation makes it possible to monitor the system after the retrofitting and to make the functionality of the control device available outside the system. This makes it possible for the maintenance of the installation to be better prepared and carried out more efficiently.

In a preferred embodiment, the method further comprises receiving a reset command via the communication unit and generating a reset signal for the control device of the passenger transport installation.

The method thus makes it possible to initiate a reset, i.e. restart, of this control device remotely when a non-functional control is detected by sending a reset signal via the communication unit which is then forwarded to the control device. In a particularly preferred embodiment, this forwarding takes place from the communication unit to the control device via the second and third interfaces of the device as described above and below. The device makes it possible to route the reset command or reset signal unchanged to the control device via the already existing connection (first and second interface) of the device to the communication unit. This allows remote resets without the need for a further connection to the communication unit.

### DESCRIPTION OF THE DRAWINGS

The invention is explained in more detail below with reference to embodiments in the drawings, which show:

FIG. 1: a schematic representation of a first embodiment of a device according to the invention.

FIG. 2: a schematic representation of a first embodiment of a system according to the invention.

FIG. 3: a schematic representation of a passenger transport installation retrofitted according to the method according to the invention.

FIG. 4: the device known from FIG. 1 in a further configuration in which it is connected to the passenger transport installation differently in comparison with FIG. 1 in order to detect a different physical variable.

FIG. 5: the device from FIG. 1 connected to the passenger transport installation according to the invention.

FIG. 6: a schematic representation of a further embodiment of a device according to the invention.

FIG. 7: the device from FIG. 6 connected to the passenger transport installation.

FIG. 8: a passenger transport installation with three identical devices according to the embodiment from FIG. 1, but different configurations with regard to the connections to the passenger transport installation for the detection of three different physical variables, a device according to the embodiment of FIG. 6, and a communication unit.

### DETAILED DESCRIPTION

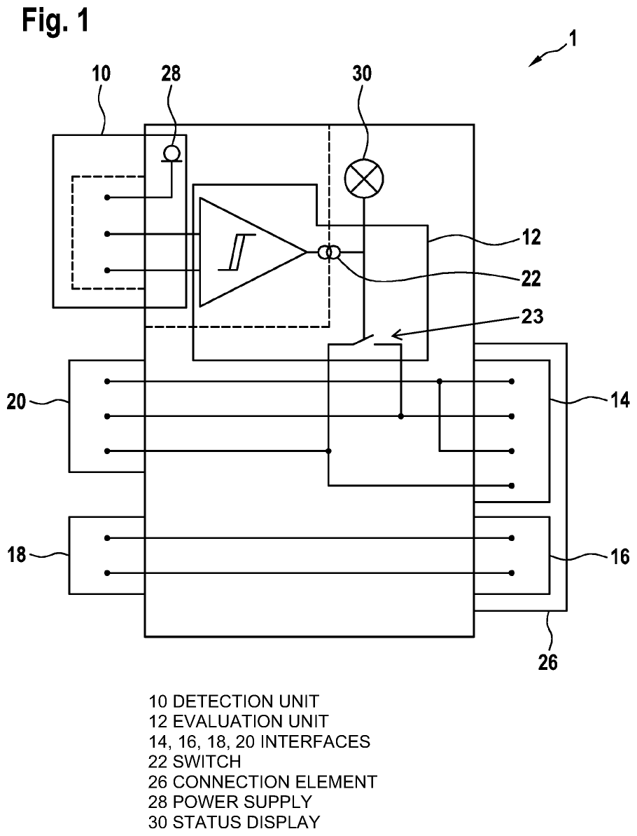

FIG. 1 shows a device 1. The device 1 comprises a detection unit 10 and an evaluation unit 12, as well as several interfaces 14, 16, 18, 20 for connecting the device. The device further comprises a switch 22 and a status display 30. In this embodiment, the detection unit 10 is in the form of an interface having three pins. The power supply 28 of the device 1 can be led out of the device 1 via a first pin. The second pin connects a first input of the evaluation unit 12 to the detection unit 10, the third pin connecting a second input of the evaluation unit 12 to the detection unit 10. In this embodiment, the evaluation unit 12 comprises a comparator and an inverter which can be actuated by the switch 22. The comparator is connected to the second and third pin of the detection unit 10. On the basis of the output signal, which can be inverted by the inverter (depending on the position of the switch 22), the evaluation unit 12 closes or opens a switch 23 that is integrated in the evaluation unit such that a circuit that contains this switch is either closed or interrupted. The two connections of this switch are led out of the evaluation unit 12. The interfaces 14, 16, 18, 20 are configured as follows in this embodiment: The first interface 14 comprises four pins for connecting the device 1. The second interface 16 comprises two pins. In this embodiment, the first interface 14 and the second interface 16 are formed in a connection element 26, which is a plug in this embodiment. The third interface 18 comprises two pins. In this embodiment, the two pins of the second interface 16 are directly connected within the device to the two pins of the third interface 18. The additional interface 20 comprises three pins. The first pin of the first interface 14 is connected to the third pin of the first interface 14 and to the first pin of the additional interface 20. The second pin of the first interface 14 is connected to the second pin of the additional interface 20 and to the first connection of the switch 23 of the evaluation unit 12 that is led out of the evaluation unit 12. The fourth pin of the first interface 14 is connected to the third pin of the additional interface 20 and to the second connection of the switch 23 present in the evaluation unit 12, which connection is led out of the evaluation unit 12. A status display 30 is connected to the output of the comparator through the switch 22.

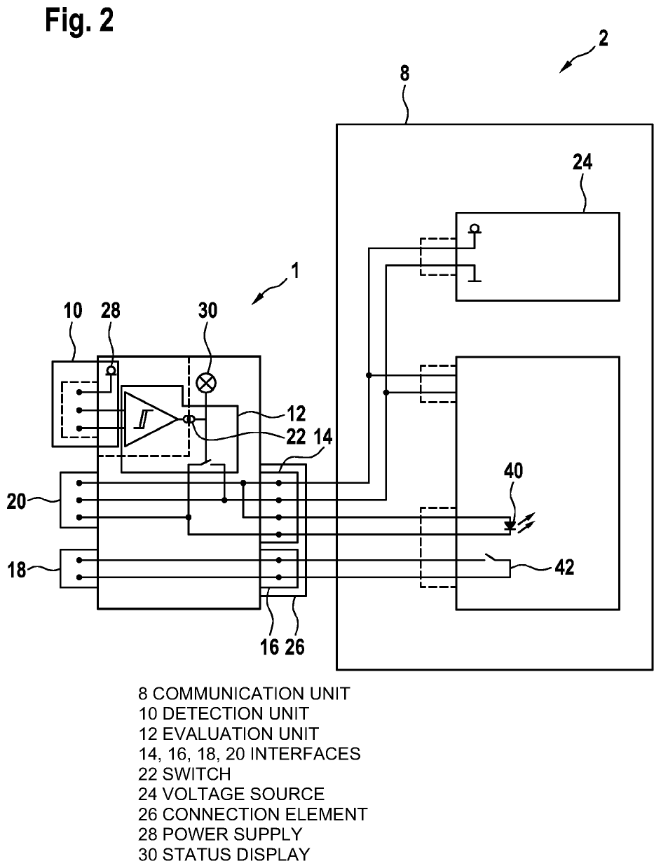

FIG. 2 shows a system 2. In this embodiment, the system 2 consists of a device 1, as shown in FIG. 1, and a communication unit 8. The communication unit 8 comprises a voltage source 24. The voltage source 24 is led out of the communication unit 8 and connected to the device 1 via the first and second pins of the first interface 14 of the device 1. The communication unit 8 has a digital input 40 and two pins which allow the digital input 40 to be contacted. These two pins are configured as the second and third pins of the communication unit 8. The communication unit 8 further comprises a digital output 42. This digital output can be tapped via two pins, namely the fifth and sixth pins of the communication unit 8, outside the communication unit 8. The digital input 40 is connected to the third and fourth pins of the first interface 14. The digital output 42 is connected to the second interface 16 of the device 1 via the fifth and sixth pins of the communication unit 8.

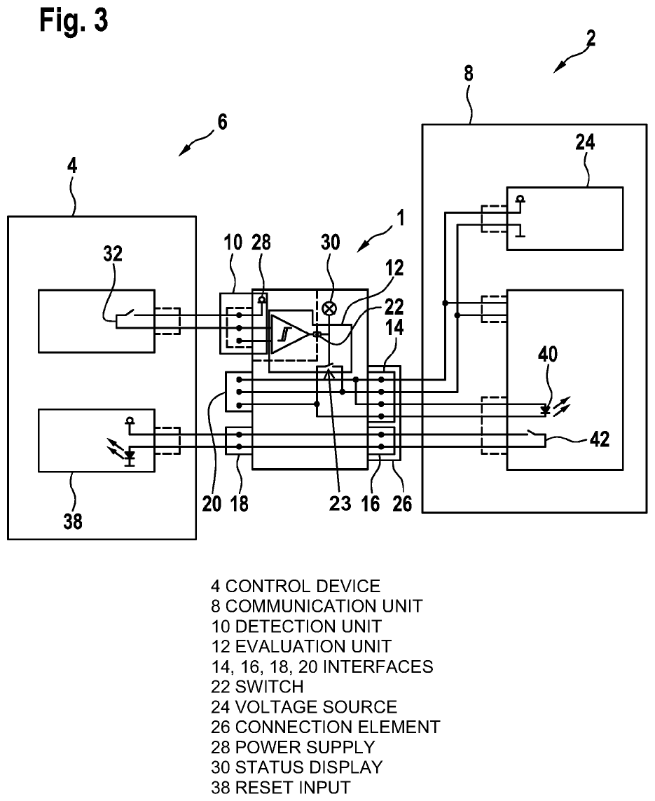

FIG. 3 shows the system 2 described above after it has been connected to a passenger transport installation 6 or the control device 4 of the installation 6 by means of a retrofitting method according to the invention. In this embodiment, a so-called cold switch signal output of the control device 4 is detected by the detection unit 10 of the device 1 of the system 2, and the physical variable of an electrical resistance representing the status of a switch 32 is thus detected by the system 2. For this purpose, the first pin and the second pin of the detection unit 10 are connected to the signal output of the switch 32 of the control device 4. The control device 4 also includes a reset input 38, this input 38 being connected to the third interface 18 of the device 1. A reset command of the digital output 42 of the communication unit 8 is thus routed through the device 1, i.e. through the second interface 16 and third interface 18, to the control device 4. As a result of the above-described connection of the system 2 to the control device 4, a closure of the switch 32, i.e. a change in the resistance of the switch 32 from almost infinite to zero ohms, results in a current flow from the voltage source 28, which is supplied with power by the voltage source 24 (connection not shown), to the first input of the comparator. This leads to a positive output voltage at the output of the comparator and thus to a closed switch 23. When the switch 23 is closed, a current flow through the digital input 40 of the control device 4 is enabled. This current flow takes place from the voltage source 24 of the communication unit 8 via the first pin of the first interface 14 into the device 1 and via the third pin of the first interface 14 out of the device 1 into the digital input 40 of the communication unit 8. From the communication unit 8, the current flow leads via the fourth pin of the first interface 14 into the device 1 and then via the switch 23 of the comparator of the detection unit 10 and the second pin of the first interface 14 back into the voltage source 24 of the communication unit 8. Such a current flow is detected by the communication unit 8 as an error signal, for example (current flow equals non-functional, no current flow equals functional). The inverter, which is part of the evaluation unit 12 and can be switched on or off by the switch 22, now allows both a normally open cold switch (open cold switch when the control device is functional) and a normally closed cold switch (closed cold switch if the control device is functional) to be connected to the same communication unit.

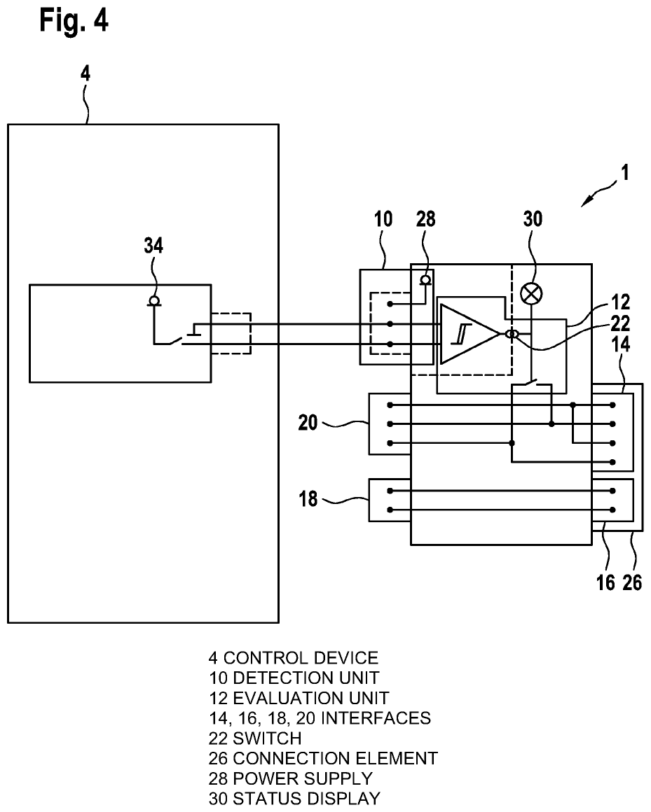

FIG. 4 shows a device 1 according to the embodiment in FIG. 1, as well as a control device 4 of a passenger transport installation 6. In contrast to the embodiment in FIG. 3, the control device 4 has a hot switch 34 (see cold switch 32 in FIG. 3). At the output of the control device 4, the hot switch 34 leads to a first physical variable which is voltage-free, i.e. 0 V, in a first state, and to a positive DC voltage, e.g. 5 V, in a second state, for example. In order to detect the first physical variable in the form of a voltage (hot switch), the device 1 from FIG. 1 is connected to the control device 4 via the second and third pin of the detection unit 10 in this embodiment. The inputs of the comparator of the evaluation unit 12 are both connected to the control device, i.e. to the voltage source of the hot switch output. The power supply 28 of the detection unit is not used in this configuration. Similarly to the description from FIG. 3, a first state and a second state of the electrical voltage can be detected, it being possible to invert the conversion of the information by means of the inverter of the evaluation unit 12 such that the communication unit 8 is independent of the implementation of the hot switch (0 V voltage can indicate a functional control device in one embodiment of the control device and a non-functional control device in another embodiment). The device 1 is identical to the device 1 from FIG. 1.

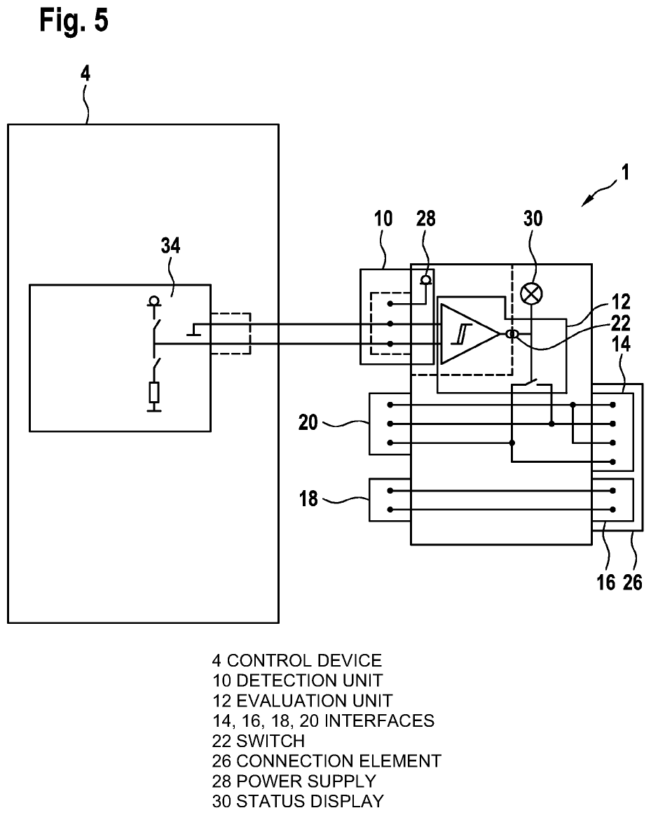

Like FIG. 4, FIG. 5 shows an embodiment according to the invention of the device 1 shown in FIG. 1 in conjunction with a control device 4 of a passenger transport installation. In this embodiment, the control device 4 has a signal output which is connected to the safety circuit 34 of the passenger transport installation. In the embodiment shown, the safety circuit 34 is a series connection of two switches between a voltage source and the ground. Each of these switches represents a safety-relevant function of the passenger transport installation. If both switches are closed, the voltage of the voltage source is present at the signal output. When the upper switch is opened, 0 V is present at the output. When the lower switch is opened, the supply voltage can be detected at the output. The state of the safety circuit 34 can therefore be tapped by the device 1 and this information can be made accessible to the communication unit 8. This embodiment is identical in principle to the embodiment from FIG. 4. In this embodiment, too, a voltage is detected as the first physical variable (i.e. a hot switch). Only the second and third pins of the detection unit 10 are connected to the control device 4. The power supply 28 at pin one of the detection unit 10 is not required.

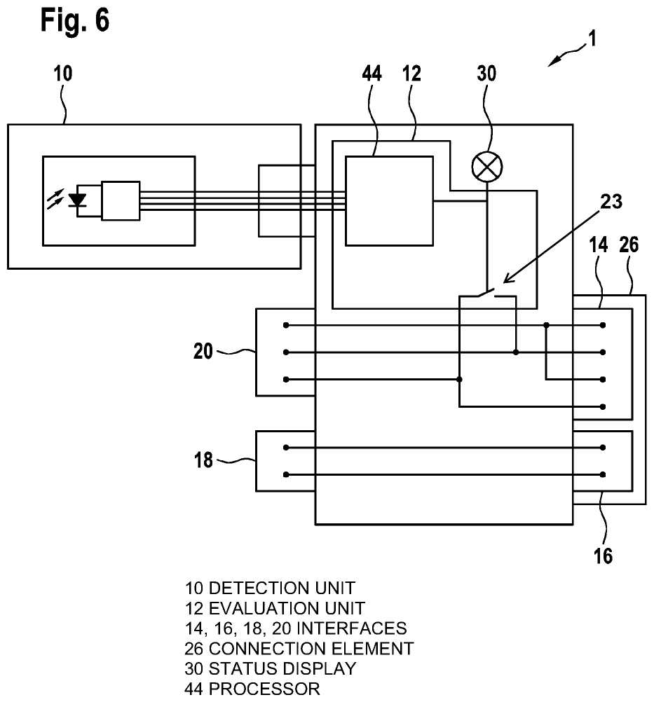

FIG. 6 shows a further embodiment of the device 1. In this embodiment, the device 1 comprises a detection unit 10 which comprises a photoelectric sensor. This is connected to the evaluation unit 12 via a converter. In this embodiment, the evaluation unit 12 comprises a processor 44 instead of the comparator. The output of the processor 44 is in turn connected to a switch 23 so that the processor can open or close this switch. The structure of the device 1 is otherwise identical to the device 1 according to the first embodiment from FIG. 1.

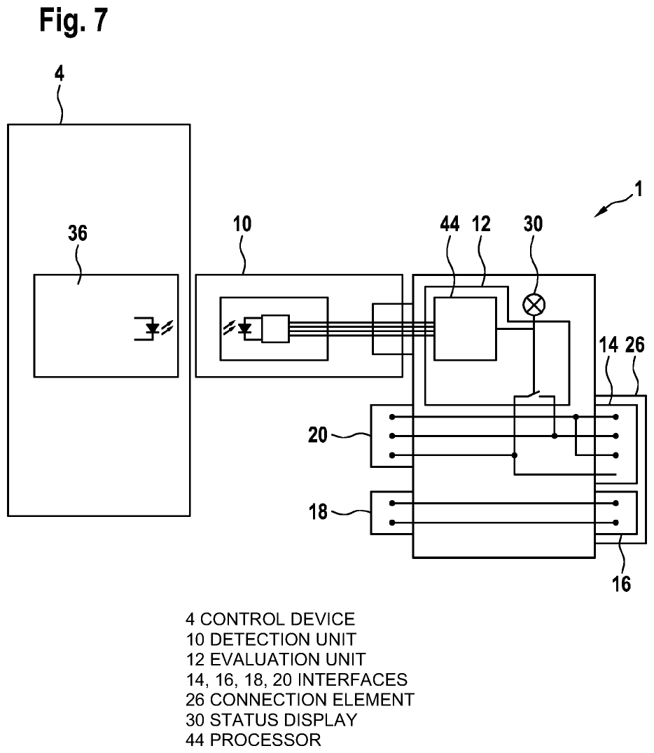

FIG. 7 shows the connection of a device 1 according to the second embodiment from FIG. 6 to a control device 4 of a passenger transport installation. In this embodiment, the control device 4 of the passenger transport installation has an LED 36 which indicates a state of the control device. In this embodiment, a green light on the LED means a functional control device, while a red light on the LED indicates a non-functional control device. In this embodiment, the first physical variable of the control device 4 is therefore a visual state, which can assume two states. This first physical variable of the control device 4 is detected by the detection unit 10 (photoelectric sensor) of the device 1 and processed by the evaluation unit 12 of the device 1 and then output as a simple binary signal at the output of the evaluation unit 12 in the form of an open or closed switch. The device 1 thus allows the detection of the physical variable, the visual state of the control device 4, and a conversion, so that the communication unit 8 can process the state of this physical variable (functional or non-functional control device), i.e. transmit it to a remote entity. There is no inverter in this embodiment, since the adaptation of the control device signaling to the logic of the communication unit is carried out by the CPU 44.

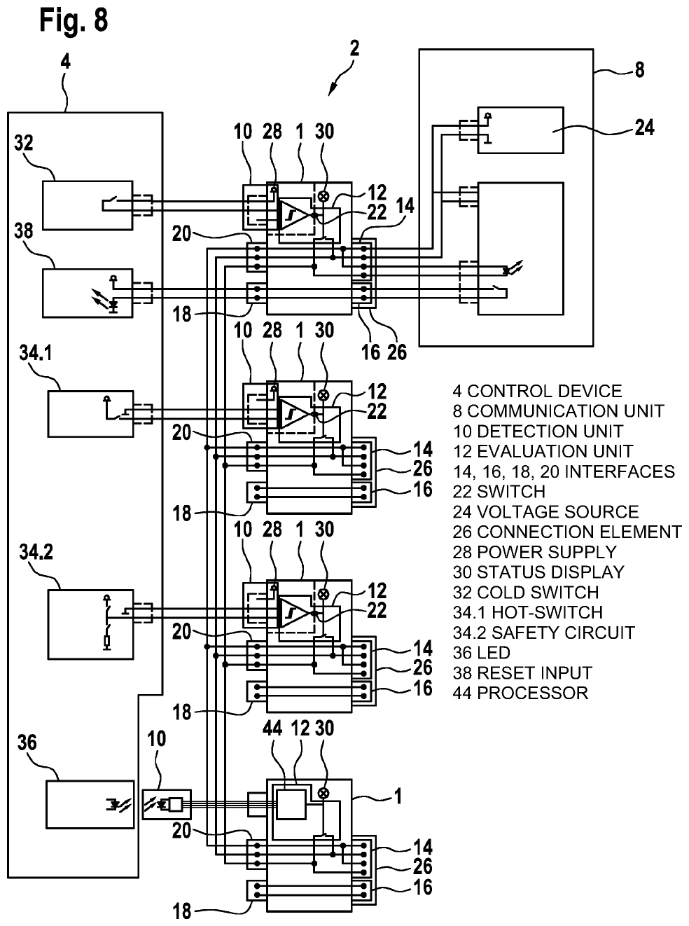

FIG. 8 shows a system 2 consisting of four devices 1 and a communication unit 8, the system 2 being connected to a control device 4 of a passenger transport installation. In this embodiment, the control device 4 comprises four signaling outputs, i.e. outputs indicating the operating state. These outputs signal different operating states through different physical variables, each of these physical variables being able to change from an “OK” state to an “out of order” state, i.e. from a first to a second state. Three of the four devices 1 are identical, specifically according to the embodiment from FIG. 1. The fourth device 1 (bottom of the figure) is configured according to the embodiment from FIG. 6. The device 1 shown at the top is connected to the control device 4 in such a way that it can detect the physical variable of electrical resistance, i.e. open or closed switch (cold switch). The two middle devices 1 are connected to the control device 4 in such a way that they can distinguish a zero voltage from a positive voltage (hot switch). One of these two devices 1 is connected to a conventional hot-switch status output 34.1 of the control device 4, while the other device 1 is connected to the safety circuit 34.2 of the passenger transport installation. The fourth, lowermost device 1 detects a state that is visually signaled by the control device 4. The four devices 1 are connected to one another in a bus-like manner via the additional interface 20. The uppermost device 1 is connected to the communication unit 8 as described above. If one of the evaluation units 12 of the devices 1 closes the switch on the basis of the detected first physical variable, this leads to a current flow as described above, which is then evaluated by the communication unit 8 as a non-functional control device. In this embodiment, the various devices 1 are OR-linked to one another, the result of the OR link being passed to the communication unit 8. Using the inverters present in the devices 1 or the CPU 44 present in the fourth device 1, the signal coding can be adapted to the physical variable such that the relevant switch of the evaluation unit 12 only actually opens when the physical variable indicates a non-functional control device. In such a configuration, the plurality of devices 1, which are configured as simple devices 1, as described above, make it possible to detect a plurality of different physical variables of the control device 4, to adapt them by the inverter, to OR-link them, and then to route them via a simple two-wire connection to the communication unit 8 as a simple digital on or off signal.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A device for connecting a control device of a passenger transport installation to a communication unit remote from the device to transmit data to an entity remote from the passenger transport installation, the device comprising:
a detection unit adapted to detect a first physical variable of the control device;
an evaluation unit generating a first electrical signal on a basis of the detected first physical variable;
a first interface connecting the device to the communication unit, wherein the first electrical signal is transmitted to the communication unit via the first interface; and
wherein the detection unit detects the first physical variable as at least one of an electrical resistance, an electrical voltage, a visual state and an acoustic signal of the control device.

17. The device according to claim 16 wherein the evaluation unit differentiates between a first state and a second state of the first physical variable, wherein the first state indicates that the passenger transport installation is functional and the second state indicates that the passenger transport installation is not functional.

18. The device according to claim 17 wherein the evaluation unit includes a switch for switching the evaluation unit between a first operating mode and a second operating mode, wherein the first electrical signal is generated in a first state when the evaluation unit is in the first operating mode and is inverted from the first state to a second state when the evaluation unit is in the second operating mode.

19. The device according to claim 18 wherein the evaluation unit, when operating in the first operating mode, generates the first electrical signal in the first state when the first state of the first physical variable is detected and generates the first electrical signal in the second state when the second state of the first physical variable is detected and, when operating in the second operating mode, generates the first electrical signal in the second state when the first state of the first physical variable is detected and generates the first electrical signal in the first state when the second state of the first physical variable is detected.

20. The device according to claim 16 including a second interface and a third interface, wherein the second interface is electrically connected to the third interface within the device such that an electrical signal that is present at one of the second and third interfaces is also available at another of the second and third interfaces.

21. The device according to claim 20 wherein the second interface is formed in a connection element with the first interface.

22. The device according to claim 16 wherein the device is connected to a voltage source of the communication unit to supply the device with electrical power, and wherein the voltage source is connected to the device via the first interface.

23. The device according to claim 16 wherein the passenger transport installation is an elevator installation.

24. the device according to claim 16 wherein the communication unit is an Internet-enabled communication unit.

25. A system including two of the devices according to claim 16 each having an additional interface, the additional interfaces connecting the two devices.

26. The system according to claim 25 wherein the first electrical signals of the two devices are OR-linked or AND-linked to generate a resulting signal that is transmitted to the communication unit via the first interface.

27. A system for transmitting a state of a control device of a passenger transport installation, the system comprising:
a communication unit for transmitting data to an entity remote from the passenger transport installation; and
at least one of the device according to claim 16 connected to the communication unit via the first interface.

28. The system according to claim 27 wherein the at least one device includes a first device and a second device, wherein the first device is connected to an additional interface of the second device via an additional interface of the first device, wherein the first device and the second device are configured identically, wherein the detection unit of the first device detects the first physical variable of the control device that is at least one of an electrical resistance, an electrical voltage, a visual state of the control device and an acoustic signal of the control device, wherein the detection unit of the second device detects a second physical variable of the control device that is different from the first physical variable and is at least one of an electrical resistance, an electrical voltage, a visual signal from the control device, or an acoustic signal from the control device.

29. The system according to claim 28 wherein the at least one device includes a third device connected to the additional interfaces of the first and second devices via an additional interface of the third device, wherein the detection unit of the third device detects a visual signal from the control device.

30. The system according to claim 27 wherein the at least one device includes a second interface connected to the communication unit and a third interface connected to the control device, and wherein the first interface and the second interface are formed in a connection element.

31. A method for retrofitting a passenger transport installation, the method comprising the steps of:
attaching at least one device according to claim 16 to a control device of the passenger transport installation; and
attaching a communication unit to the passenger transport installation and connecting the communication unit to the at least one device.

32. The method according to claim 31 wherein the passenger transport installation is a non-Internet-enabled elevator installation connected to a building management via parallel wiring and the communication unit is an Internet-enabled communication unit.

33. The method according to claim 31 including transmission of an operating state of the control device of the passenger transport installation to an entity remote from the passenger transport installation, the method further comprising the steps of:
monitoring with the at least one device at least one physical variable of the control device that indicates that the control device is functional, the at least one physical variable being at least one of an electrical resistance, an electrical voltage, a visual signal of the control device and an acoustic signal of the control device; and
transmitting an error message to an entity outside the passenger transport installation when the at least one physical variable indicates that the control device is not functional.

34. The method according to claim 31 including receiving a reset command via the communication unit and responding by generating a reset signal to the control device of the passenger transport installation.
